(19) United States
(12) Patent Application Publication
(10) Pub. No.: US 2015/0304680 A1
(43) Pub. Date: Oct. 22, 2015

(54) MOTION DETECTION CIRCUIT AND METHOD

(71) Applicant: Chih-Hung Ling, Hsinchu (TW)

(72) Inventor: Chih-Hung Ling, Hsinchu (TW)

(73) Assignee: FARADAY TECHNOLOGY CORP., Hsinchu (TW)

(21) Appl. No.: 14/297,570

(22) Filed: Jun. 5, 2014

(30) Foreign Application Priority Data
Apr. 16, 2014 (TW) 103113887

(51) Int. Cl. H04N 19/513; H04N 19/44

(52) U.S. Cl. CPC H04N 19/521; H04N 19/44

(57) ABSTRACT

A motion detection circuit and a motion detection method are provided. The motion detection circuit includes a motion vector (MV) filtering unit and a MV decision unit. According to a relationship between a MV of a current macro-block (MB) and MVs of spatial neighboring MBs, or according to a relationship between the MV of the current MB and the MV of temporal neighboring MB, the MV filtering unit determines whether to filter the MV of the current MB for obtaining a first filtered information of the current MB. The MV decision unit receives the first filtered information, and determines whether the current MB is a motion MB according to the first filtered information.

### CROSS-REFERENCE TO RELATED APPLICATION

This application claims the priority benefit of Taiwan application serial no. 103113887, filed on Apr. 16, 2014. The entirety of the above-mentioned patent application is hereby incorporated by reference herein and made a part of this specification.

### BACKGROUND OF THE INVENTION

1. Field of the Invention

The invention relates to a video apparatus, and more particularly, relates to a motion detection circuit and a motion detection method.

2. Description of Related Art

In modern life, people may watch different video contents through a display. In order to save transmission frequency band width and/or storage space, it is possible that the video contents have been compressed in advance. A video decoder in a player is capable of decompressing compressed video data (video stream) for showing the video contents for users. During process of decompressing, the video decoder needs to perform motion detection on the compressed video information. However, accuracy of the motion detection cannot be easily improved because information obtained from the compressed video data by the video decoder is relatively fewer.

### SUMMARY OF THE INVENTION

The invention is directed to a motion detection circuit and a motion detection method for a video decoder, capable of performing a motion detection through information of the compressed video data.

A motion detection circuit for a video decoder is provided according to the embodiments of the invention, which includes a motion vector filtering unit and a motion vector decision unit. The motion vector filtering unit receives motion vectors of a plurality of macro-blocks in a current video frame provided by the video decoder. According to a relationship between the motion vector of a current macro-block among the macro-blocks and the motion vector of spatial neighboring macro-blocks, or according to a relationship between the motion vector of the current macro-block and the motion vector of temporal neighboring macro-blocks, the motion vector filtering unit determines whether to filter the motion vector of the current macro-block for obtaining a first filtered information of the current macro-block. An input terminal of the motion vector decision unit is coupled to an output terminal of the motion vector filtering unit to receive the first filtered information, and determines whether the current macro-block is a motion macro-block according to the first filtered information.

A motion detection method for a video decoder is provided according to the embodiments of the invention, including: receiving motion vectors of a plurality of macro-blocks in a current video frame provided by the video decoder; according to a relationship between the motion vector of a current macro-block among the macro-blocks and the motion vector of spatial neighboring macro-blocks among the macro-blocks, or according to a relationship between the motion vector of the current macro-block and the motion vector of temporal neighboring macro-blocks, determining whether to filter the motion vector of the current macro-block for obtaining a first filtered information of the current macro-block; and determining whether the current macro-block is a motion macro-block according to the first filtered information.

Based on above, the motion detection circuit and the motion detection method for the video decoder 10 according to the embodiments of the invention are capable of performing the motion detection by using the information (the motion vector and/or the encoding type information) of the compressed video data. For example, in some embodiments, according to the relationship between the motion vector of one current macro-block and the motion vector of multiple spatial neighboring macro-blocks, or according to the relationship between the motion vector of the current macro-block and the motion vector of multiple temporal neighboring macro-blocks, the motion detection circuit and the motion detection method are capable of determining whether the current macro-block is the motion macro-block.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating circuitry of a motion detection circuit for a video decoder according to an embodiment of the invention.

FIG. 2 is a flowchart illustrating a motion detection method for the video decoder according to an embodiment of the invention.

FIG. 3 is a schematic diagram illustrating the current macro-block and the spatial neighboring macro-blocks according to an embodiment of the invention.

FIG. 4 is a schematic diagram illustrating the current macro-block and the temporal neighboring macro-blocks according to an embodiment of the invention.

FIG. 5 is a block diagram illustrating circuitry of a motion detection circuit for the video decoder according to another embodiment of the invention.

FIG. 6 is a block diagram illustrating circuitry of the motion vector filtering unit depicted in FIG. 5 according to an embodiment of the invention.

FIG. 7 is a block diagram illustrating circuitry of a motion detection circuit for the video decoder according to yet another embodiment of the invention.

FIG. 8 is a block diagram illustrating circuitry of a motion detection circuit for the video decoder according to still another embodiment of the invention.

FIG. 9 is a flowchart illustrating a motion detection method for the video decoder according to another embodiment of the invention.

### DESCRIPTION OF THE EMBODIMENTS

The term “coupling/coupled” used in this specification (including claims) may refer to any direct or indirect connection means. For example, “a first device is coupled to a second device” should be interpreted as “the first device is directly connected to the second device” or “the first device is indirectly connected to the second device through other devices or connection means.” Moreover, wherever appropriate in the drawings and embodiments, elements/components/steps with the same reference numerals represent the same or similar parts. Elements/components/steps with the same reference numerals or names in different embodiments may be cross-referenced.

FIG. 1 is a block diagram illustrating circuitry of a motion detection circuit 100 for a video decoder 10 according to an embodiment of the invention. The video decoder 10 is capable of decoding a compressed video data (video stream) VS, so as to obtain motion related information (e.g., a motion vector 11 and/or other information) of a plurality of macro-blocks (MBs) in a current video frame from the compressed video data (video stream) VS. In some embodiments, the video decoder 10 may be a H.264 decoder, a MPEG-4 decoder or other decoders.

The video decoder 10 may output the motion vector 11 of the macro-blocks to the motion detection circuit 100. The motion detection circuit 100 may determine whether the current macro-block is a motion macro-block according to the motion vector 11 provided by the video decoder 10 for correspondingly sending an alarm event AE according to a block amount of those determined as the motion macro-block in the current video frame. The alarm event AE indicates whether the current video frame belongs to a motion frame. If the block amount of the motion macro-blocks in the current video frame exceeds a predefined threshold TH1, the current video frame may be considered as the motion frame. The alarm event AE may be provided to a decompression circuit (not illustrated) and/or other video processing circuits. For instance, a video decompressor (not illustrated) may decompress the compressed video data (video stream) VS according to the alarm event AE.

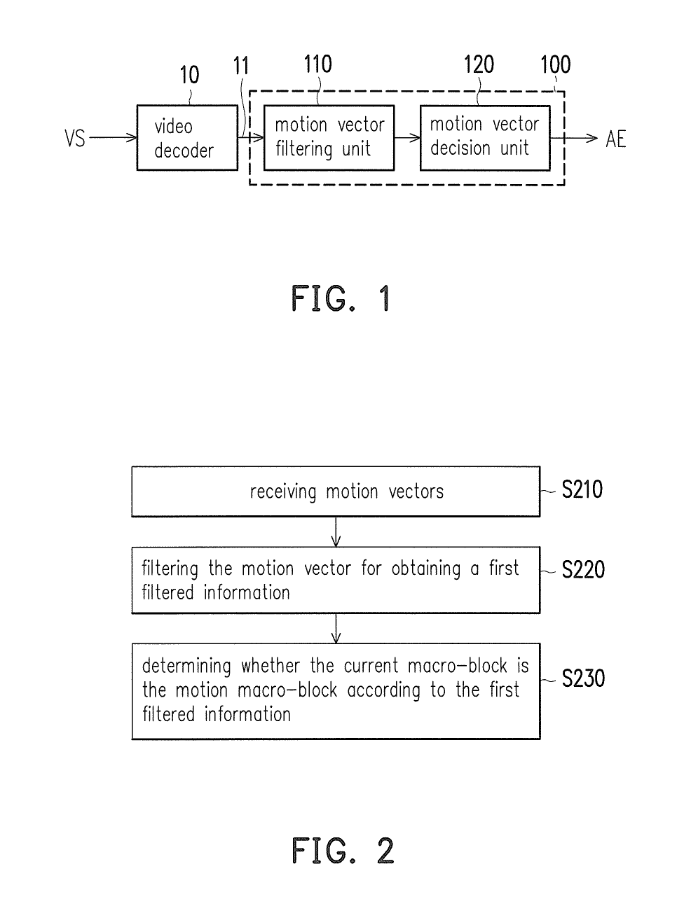

FIG. 2 is a flowchart illustrating a motion detection method for the video decoder 10 according to an embodiment of the invention. Referring to FIG. 1 and FIG. 2, the motion detection circuit 100 includes a motion vector filtering unit 110 and a motion vector decision unit 120. The motion vector filtering unit 110 receives motion vectors 11 provided by the video decoder 10 in step S210. In step S220, according to a relationship between the motion vector of one current macro-block among the macro-blocks and the motion vector of one or more spatial neighboring macro-blocks, and/or according to a relationship between the motion vector of the current macro-block and the motion vector of one or more temporal neighboring macro-blocks, the motion vector filtering unit 110 may determine whether to filter the motion vector of the current macro-block for obtaining a first filtered information of the current macro-block.

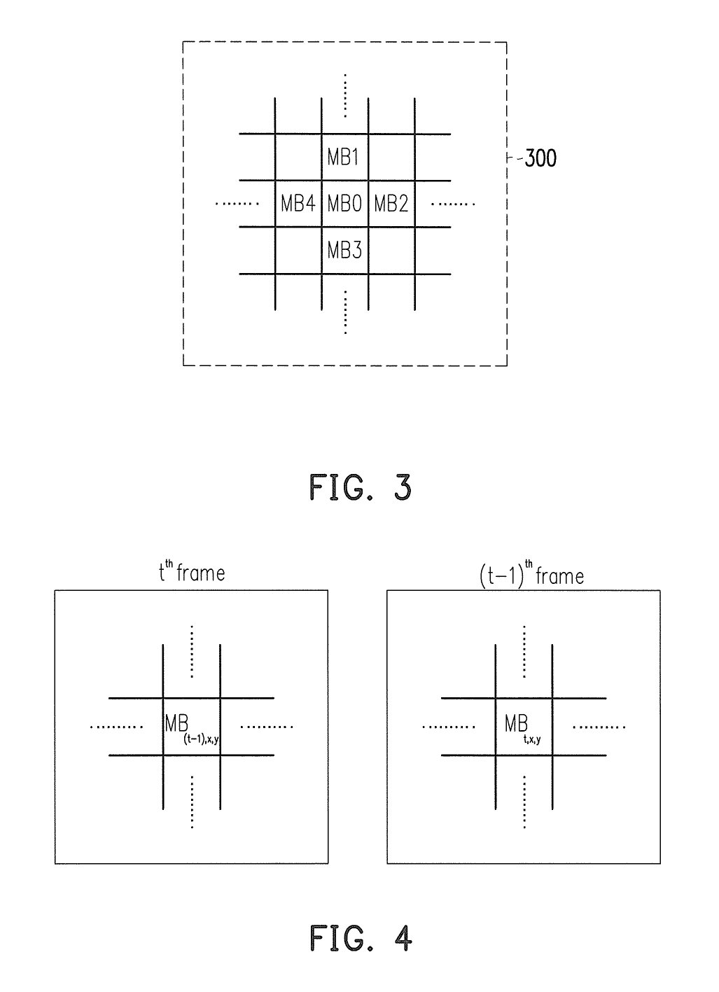

For instance, FIG. 3 is a schematic diagram illustrating the current macro-block and the spatial neighboring macro-blocks according to an embodiment of the invention. A current video frame 300 includes a plurality of macro-blocks, such as macro-blocks MB0, MB1, MB2, MB3 and MB4 depicted in FIG. 3. In case the current macro-block is the macro-block MB0, the spatial neighboring macro-blocks include the macro-blocks being directly or indirectly adjacent thereto. For instance, in the preset embodiment, the spatial neighboring macro-blocks may be two neighboring macro-blocks (i.e., the macro-block MB1 and the macro-block MB2) adjacent to the current macro-block MB0 on a column direction and two neighboring macro-blocks (i.e., the macro-block MB3 and the macro-block MB4) adjacent to current macro-block MB0 on a row direction. According to a relationship between the motion vector of the current macro-block MB0 and the motion vectors of the spatial neighboring macro-blocks MB1 to MB4, the motion vector filtering unit 110 may determine whether to filter the motion vector of the current macro-block MB0 for obtaining a first filtered information of the current macro-block MB0 in step S220.

For another instance, FIG. 4 is a schematic diagram illustrating the current macro-block and the temporal neighboring macro-blocks according to an embodiment of the invention. Herein, it is assumed that the current video frame is a t^{th} frame. The current video frame (the t^{th} frame) includes a plurality of macro-blocks, such as a macro-block MB_{t,x,y} depicted in FIG. 4. MB_{t,x,y} represents the macro-block at a position x,y in a t^{th} video frame. In case the current macro-block is the macro-block MB_{t,x,y}, the spatial neighboring macro-blocks include a macro-blocks MB_{(t-1),x,y} at the same position in a previous video frame (a t−1^{th} frame). According to a relationship between the motion vector of the current macro-block MB_{t,x,y} and the motion vector of the spatial neighboring macro-block MB_{(t-1),x,y}, the motion vector filtering unit 110 may determine whether to filter the motion vector of the current macro-block MB_{t,x,y} for obtaining the first filtered information of the current macro-block MB_{t,x,y} in step S220.

Referring to FIG. 1 and FIG. 2, an input terminal of the motion vector decision unit 120 is coupled to an output terminal of the motion vector filtering unit 110 to receive the first filtered information. According to the first filtered information, the motion vector decision unit 120 may determine whether the current macro-block is the motion macro-block in step S230. For instance, the motion vector decision unit 120 may determine whether the current macro-block is the motion macro-block according to a relationship between the first filtered information and a threshold TH2. When the first filtered information of the current macro-block is greater than the threshold TH2, the motion vector decision unit 120 may determine that the current macro-block is the motion macro-block in step S230. Otherwise, the current macro-block is a non-motion macro-block. The motion vector decision unit 120 may correspondingly send the alarm event AE according to the block amount of those determined as the motion macro-block in the current video frame.

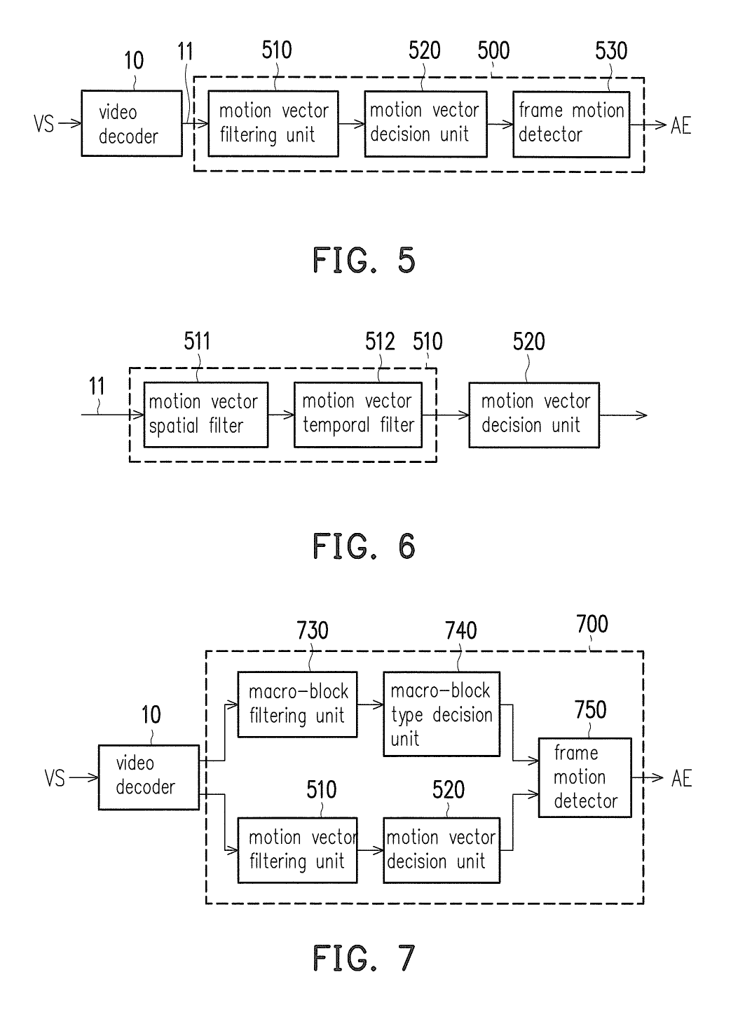

FIG. 5 is a block diagram illustrating circuitry of a motion detection circuit 500 for the video decoder 10 according to another embodiment of the invention. The video decoder 10 and the motion detection circuit 500 depicted in FIG. 5 may be inferred by reference with related description for the video decoder 10 and the motion detection circuit 100 depicted in FIG. 1. The motion detection circuit 500 includes a motion vector filtering unit 510, a motion vector decision unit 520, and a frame motion detector 530. The motion vector filtering unit 510 and the motion vector decision unit 520 depicted in FIG. 5 may be inferred by reference with related description for the motion vector filtering unit 110 and the motion vector decision unit 120 depicted in FIG. 1. Referring to FIG. 5, the motion vector filtering unit 510 may determine whether to filter the motion vector of the current macro-block for obtaining the first filtered information of the current macro-block. The motion vector decision unit 520 may determine whether the current macro-block is the motion macro-block according to the relationship between the first filtered information and the threshold TH2. When the first filtered information of the current macro-block is greater than the threshold TH2, the motion vector decision unit 520 may inform the frame motion detector 530 that the current macro-block is the motion macro-block through the first filtered information. Otherwise, the current macro-block is the non-motion macro-block. An input terminal of the frame motion detector 530 is coupled to an output terminal of the motion vector decision unit 520. According to the first filtered information of different macro-blocks provided by the motion vector decision unit 520, the frame motion detector 530 may count the block amount of those determined as the motion macro-block among the macro-blocks in the current video frame, and determine whether the current video frame is a motion video frame, so as to correspondingly send the alarm event AE.

FIG. 6 is a block diagram illustrating circuitry of the motion vector filtering unit 510 depicted in FIG. 5 according to an embodiment of the invention. An implementation of the motion vector filtering unit 110 depicted in FIG. 1 may also be inferred by reference with related description for the motion vector filtering unit 510 depicted in FIG. 6. Referring to FIG. 6, the motion vector filtering unit 510 includes a motion vector spatial filter 511 and a motion vector temporal filter 512. An input terminal of the motion vector spatial filter 511 receives the motion vectors 11 of the different macro-blocks provided by the video decoder 10. According to the relationship between the motion vector of the current macro-block and the motion vectors of the spatial neighboring macro-blocks, the motion vector filtering unit 511 may determine whether to filter the motion vector of the current macro-block for obtaining a spatial filtered motion vector of the current macro-block. By analogy, the motion vector spatial filter 511 may obtain the spatial filtered motion vectors of all the macro-blocks in the current video frame.

For instance, in some embodiments, the motion vector spatial filter 511 may check a vector angle difference between the motion vector of each of the spatial neighboring macro-blocks and the motion vector of the current macro-block. Taking FIG. 3 for example, it is assumed that a difference between a vector angle of the current macro-block MB0 and a vector angle of the spatial neighboring macro-block MB1 is A1. When the vector angle difference A1 is less than a predetermined threshold TH3, it indicates that the motion vector of the current macro-block MB0 is very similar to the motion vector of the spatial neighboring macro-block MB1. By analogy, a difference between the vector angle of the current macro-block MB0 and a vector angle of the spatial neighboring macro-block MB2 is A2, a difference between the vector angle of the current macro-block MB0 and a vector angle of the spatial neighboring macro-block MB3 is A3, and a difference between the vector angle of the current macro-block MB0 and a vector angle of the spatial neighboring macro-block MB4 is A4. When one of the vector angle differences A1 to A4 is less than the threshold TH3, the motion vector spatial filter 511 may maintain the motion vector of the current macro-block MB0 to be served as the spatial filtered motion vector of the current macro-block MB0. In other words, the current macro-block MB0 may now be considered as a candidate motion macro-block.

When the vector angle differences A1 to A4 are all greater than the threshold TH3, the motion vector spatial filter 511 may reset the motion vector of the current macro-block MB0 to a first default motion vector representing the non-motion macro-block to be served as the spatial filtered motion vector of the current macro-block MB0. For instance, when the vector angle differences A1 to A4 are all greater than the threshold TH3, the motion vector spatial filter 511 may reset the motion vector (MVx,MVy) of the current macro-block MB0 to (0,0) or other values, so as to be served as the spatial filtered motion vector of the current macro-block MB0. Accordingly, the motion vector spatial filter 511 is capable of filtering noises in the motion vector 11. After filtering said noises, when all the spatial neighboring macro-blocks MB1 to MB4 are the motion macro-block (the candidate motion macro-block), the motion vector spatial filter 511 may adjust the spatial filtered motion vector of the current macro-block MB0 reset to the first default motion vector to a second default motion vector representing the motion macro-block. For instance, when all the spatial neighboring macro-blocks MB1 to MB4 are the motion macro-block (the candidate motion macro-block), the motion vector spatial filter 511 may adjust the spatial filtered motion vector of the current macro-block MB0 reset to (0,0) to be (1,1) or other values.

Practically, the implementation of the motion vector spatial filter 511 should not be limited to the above. For example, in some other embodiments, after filtering said noises, when two (or more) of the spatial neighboring macro-blocks are the motion macro-block (the candidate motion macro-block), the motion vector spatial filter 511 may adjust the spatial filtered motion vector of the current macro-block MB0 reset to the first default motion vector to the second default motion vector. For instance, when both the spatial neighboring macro-blocks MB1 and MB2 are the motion macro-block (the candidate motion macro-block) but the spatial neighboring macro-blocks MB3 and MB4 are the non-motion macro-block, the motion vector spatial filter 511 may then adjust the spatial filtered motion vector of the current macro-block MB0 reset to (0,0) to be (1,1) or other values.

An input terminal of the motion vector temporal filter 512 is coupled to an output terminal of the motion vector spatial filter 511 to receive the spatial filtered motion vectors of the macro-blocks. The motion vector temporal filter 512 may accumulate the spatial filtered motion vectors of the current macro-blocks at the same position in different video frames for obtaining the first filtered information of the current macro-block in the current video frame.

For instance, taking FIG. 4 for example, the motion vector temporal filter 512 may calculate an equation TMV_{t,x,y}=wₘᵥ*mvs_{t,x,y}+(1−wₘᵥ)*TMV_{(t-1),x,y} for obtaining the first filtered information TMV_{t,x,y} of the current macro-block MB_{t,x,y} at the position x,y in the current video frame (the t^{th} frame). Therein, TMV_{(t-1),x,y} represents the first filtered information of the macro-block at the same position x,y in the previous video frame (the t−1^{th} frame), mvs_{t,x,y} represents the spatial filtered motion vector of the macro-block at the same position x,y in the current video frame (the t^{th} frame), wₘᵥ represents a weight, 0≦wₘᵥ≦1, and t, x, y are integers.

Practically, the implementation of the motion vector temporal filter 512 should not be limited to the above. For example, in some other embodiments, the motion vector temporal filter 512 may normalize the spatial filtered motion vector mvs_{t,x,y} of the current macro-block MB_{t,x,y} at the position x,y in the current video frame (the t^{th} frame) for obtaining a normalized motion vector nmv_{t,x,y}. For instance, assuming that the spatial filtered motion vector mvs_{t,x,y} of the current macro-block MB_{t,x,y} is (MVx,MVy), in case MVx or MVy is greater than 0, the normalized motion vector nmv_{t,x,y} of current macro-block MB_{t,x,y} is set to 1; and in case MVx and MVy are both 0, the normalized motion vector nmv_{t,x,y} of the current macro-block MB_{t,x,y} is set to 0. After normalizing, the motion vector temporal filter 512 may calculate an equation TMV_{t,x,y}=[w₁*TMV_{(t-1),x,y}+w₂*nmV_{t,x,y}]/w₃ for obtaining the first filtered information TMV_{t,x,y} of the current macro-block MB_{t,x,y} at the position x,y in the current video frame (the t^{th} frame). Therein, nmv_{t,x,y} represents the normalized motion vector of the current macro-block MB_{t,x,y} at the same position x,y in the current video frame (the t^{th} frame), and w₁, w₂, w₃ are real numbers. The coefficients w₁, w₂, w₃ may be determined according to practical design requirements. In some embodiments, w₁+w₂>w₃. For example, the motion vector temporal filter 512 may calculate the first filtered information TMV_{t,x,y}=[2.0*TMV_{(t-1),x,y}+2.0*nmv_{t,x,y}]/3.0.

FIG. 7 is a block diagram illustrating circuitry of a motion detection circuit 700 for the video decoder 10 according to yet another embodiment of the invention. The motion detection circuit 700 includes the motion vector filtering unit 510, the motion vector decision unit 520, a macro-block filtering unit 730, a macro-block type decision unit 740 and a frame motion detector 750. The video decoder 10, the motion detection circuit 700, the motion vector filtering unit 510 and the motion vector decision unit 520 depicted in FIG. 7 may be inferred by reference with related description for the video decoder 10, the motion detection circuit 100, the motion vector filtering unit 110 and the motion vector decision unit 120 depicted in FIG. 1. The video decoder 10, the motion detection circuit 700, the motion vector filtering unit 510, the motion vector decision unit 520 and the frame motion detector 750 depicted in FIG. 7 may be inferred by reference with related description for the video decoder 10, the motion detection circuit 500, the motion vector filtering unit 510, the motion vector decision unit 520 and the frame motion detector 530 depicted in FIG. 5.

Referring to FIG. 7, the macro-block filtering unit 730 receives encoding type information of the different macro-blocks in the current video frame provided by the video decoder 10. For instance, the encoding type information may be used to mark whether an encoding method of the current macro-block belongs to an intra-coding or an inter-coding. Generally, in case the current macro-block includes fast moving objects, the current macro-block may adopt the intra-coding, or else the inter-coding is adopted. Accordingly, when the current macro-block adopts the intra-coding, the encoding type information of the current macro-block is a first logic value (e.g., 1 or other values). When the current macro-block adopts the inter-coding, the encoding type information of the current macro-block is a second logic value (e.g., 0 or other values).

According to a relationship between the encoding type information of the current macro-block and the encoding type information of the spatial neighboring macro-block, or according to a relationship between the encoding type information of the current macro-block and the encoding type information of the temporal neighboring macro-block, the macro-block filtering unit 730 may determine whether to change the encoding type information of the current macro-block for obtaining a second filtered information of the current macro-block. For instance, taking FIG. 3 for example, when the current macro-block is the macro-block MB0, according to the relationship between the encoding type information of the current macro-block MB0 and the encoding type information of the spatial neighboring macro-blocks MB1 to MB4, the macro-block filtering unit 730 may determine whether to change the encoding type information of the current macro-block MB0 for obtaining the second filtered information of the current macro-block MB0. Taking FIG. 4 for example, when the current macro-block is the macro-block MB_{t,x,y}, according to the relationship between the encoding type information of the current macro-block MB_{t,x,y} and the encoding type information of the spatial neighboring macro-block MB_{(t-1),x,y}, the macro-block filtering unit 730 may determine whether to change the encoding type information of the current macro-block MB_{t,x,y} for obtaining the second filtered information of the current macro-block MB_{t,x,y}.

An input terminal of the macro-block type decision unit 740 is coupled to an output terminal of the macro-block filtering unit 730 to receive the second filtered information, and determines whether the current macro-block is the motion macro-block according to the second filtered information. For instance, the macro-block type decision unit 740 may determine whether the current macro-block is the motion macro-block according to a relationship between the second filtered information and a threshold TH4. When the second filtered information of the current macro-block is greater than the threshold TH4, the macro-block type decision unit 740 may determine that the current macro-block is the motion macro-block, or else the current macro-block is the non-motion macro-block.

First and second input terminals of the frame motion detector 750 are respectively coupled to an output terminal of the macro-block type decision unit 740 and an output ten signal of the motion vector decision unit 520. According to the first filtered information outputted by the motion vector decision unit 520 or the second filtered information outputted by the macro-block type decision unit 740, the frame motion detector 750 may count the block amount of those determined as the motion macro-block in the current video frame. For instance, when the first filtered information provided by the motion vector decision unit 520 indicates that the current macro-block is the candidate motion macro-block, or when the second filtered information provided by the macro-block type decision unit 740 indicates that the same current macro-block is the candidate motion macro-block, the frame motion detector 750 may determine that this current macro-block belongs to the motion macro-block. By analogy, the frame motion detector 750 may count the block amount of all the macro-blocks determined as the motion macro-block, and determine whether the current video frame is the motion video frame, so as to correspondingly send the alarm event AE.

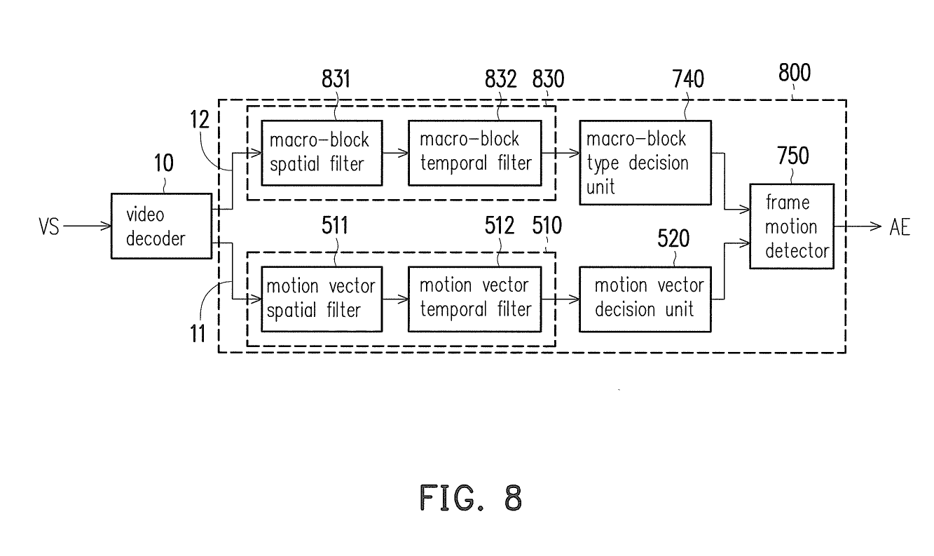

FIG. 8 is a block diagram illustrating circuitry of a motion detection circuit 800 for the video decoder 10 according to still another embodiment of the invention. The motion detection circuit 800 includes the motion vector filtering unit 510, the motion vector decision unit 520, a macro-block filtering unit 830, the macro-block type decision unit 740 and the frame motion detector 750. The embodiment depicted in FIG. 8 may be inferred by reference with related description for FIG. 7. In the embodiment depicted in FIG. 8, the motion vector filtering unit 510 includes the motion vector spatial filter 511 and the motion vector temporal filter 512. The motion vector spatial filter 511 and the motion vector temporal filter 512 depicted in FIG. 8 may be inferred by reference with related description of FIG. 6. In the embodiment depicted in FIG. 8, the macro-block filtering unit 830 includes a macro-block spatial filter 831 and a macro-block temporal filter 832. An input terminal of the macro-block spatial filter 831 receives encoding type information 12 of different macro-blocks in the current video frame.

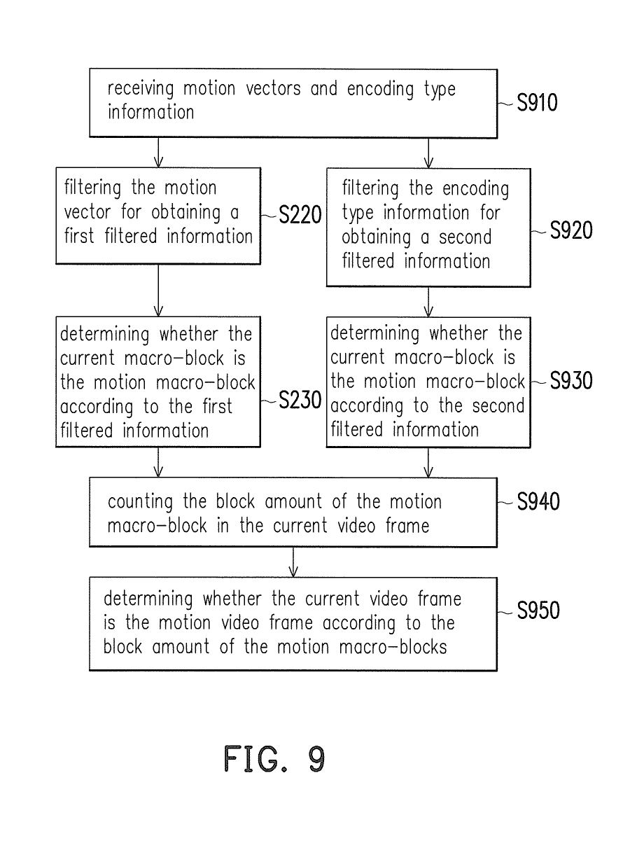

FIG. 9 is a flowchart illustrating a motion detection method for the video decoder 10 according to another embodiment of the invention. Steps S220 and S230 depicted in FIG. 9 may refer to related description of FIG. 2. Referring to FIG. 8 and FIG. 9, in step S910, output terminals of the motion vector filtering unit 110 and the macro-block spatial filter respectively receive the motion vector 11 and the encoding type information 12 of the different macro-blocks in the current video frame from the video decoder 10. In step S920, according to a relationship between the encoding type information of the current macro-block and the encoding type information of the spatial neighboring macro-blocks, the macro-block spatial filter 831 may determine whether to change the encoding type info nation of the current macro-block for obtaining a spatial filtered encoding type information of the current macro-block. By analogy, the macro-block spatial filter 831 may obtain the spatial filtered encoding type information of all the macro-blocks in the current video frame. For instance, taking FIG. 3 for example, it is assumed that the current macro-block is the macro-block MB0. When the encoding type information of the current macro-block MB0 is a first encoding type (e.g., the intra-coding) and the encoding type information of one of the spatial neighboring macro-blocks MB1 to MB4 is also the first encoding type (e.g., the intra-coding), the macro-block spatial filter 831 maintains the encoding type information of the current macro-block MB0 to be served as the spatial filtered encoding type information of the current macro-block MB0. In other words, the current macro-block MB0 may now be considered as a candidate motion macro-block.

When the encoding type information of the current macro-block MB0 is not the first encoding type (e.g., the intra-coding), or all the encoding type information of the spatial neighboring macro-blocks MB1 to MB4 are not the first encoding type (e.g., the intra-coding), the macro-block spatial filter 831 resets the encoding type information of the current macro-block MB0 to a first default encoding type information representing the non-motion macro-block, so as to be served as the spatial filtered encoding type information of the current macro-block MB0. For instance, taking FIG. 3 for example, when all the encoding type information of the spatial neighboring macro-blocks MB1 to MB4 are 0, the macro-block spatial filter 831 may reset the encoding type information of the current macro-block MB0 to 0 to be served as the spatial filtered encoding type information of the current macro-block MB0. Accordingly, the macro-block spatial filter 831 is capable of filtering noises in the encoding type information 12.

An input terminal of the macro-block temporal filter 832 is coupled to an output terminal of the macro-block spatial filter 831 to receive the spatial filtered encoding type information of the macro-blocks. The macro-block temporal filter 832 determines whether to accumulate the spatial filtered encoding type information of the current macro-blocks at the same position in different video frames according to the encoding type information of the current macro-block for obtaining the second filtered information of the current macro-block in the current video frame (step S920). For instance, taking FIG. 4 for example, it is assumed that the current macro-block is the macro-block MB_{t,x,y}. When the encoding type information of the current macro-block MB_{t,x,y} is 1 (which represents the first encoding type, such as the intra-coding), the macro-block temporal filter 832 calculates an equation AMV_{t,x,y}=AMV_{(t-1),x,y}+1 for obtaining the second filtered information AMV_{t,x,y} of the current macro-block MB_{t,x,y} at the position x,y in the current video frame (the t^{th} frame). Therein, AMV_{(t-1),x,y} represents the second filtered information of the macro-block at the same position x,y in the previous video frame (the t−1^{th} frame), and t, x, y are integers. When the encoding type information of the current macro-block MB_{t,x,y} is 0 (which represents the second encoding type, such as the inter-coding), the macro-block temporal filter 832 sets the second filtered information AMV_{t,x,y} of the current macro-block MB_{t,x,y} to 0.

An input terminal of the macro-block type decision unit 740 is coupled to an output terminal of the macro-block temporal filter 832 to receive the second filtered information AMV_{t,x,y} of the current macro-block MB_{t,x,y}. The macro-block type decision unit 740 determines whether the current macro-block MB_{t,x,y} is the motion macro-block according to the second filtered information AMV_{t,x,y} in step S930. For instance, the macro-block type decision unit 740 may determine whether the current macro-block MB_{t,x,y} is the motion macro-block according to the relationship between the second filtered information AMV_{t,x,y} and the threshold TH4. When the second filtered information AMV_{t,x,y} of the current macro-block MB_{t,x,y} is greater than the threshold TH4, the macro-block type decision unit 740 may determine that the current macro-block MB_{t,x,y} is the motion macro-block, or else the current macro-block MB_{t,x,y} is the non-motion macro-block.

The frame motion detector 750 may count the block amount of all the macro-blocks determined as the motion macro-block in the current video frame in step S940. According to the block amount counted in step S940, the frame motion detector 750 may determine whether the current video frame is the motion video frame in step S950, and thereby correspondingly sends the alarm event AE.

In summary, the motion detection circuit and the motion detection method for the video decoder 10 according to the embodiments of the invention are capable of performing the motion detection by using the information (the motion vector and/or the encoding type information) of the compressed video data. For example, in some embodiments, according to the relationship between the motion vector of one current macro-block and the motion vector of multiple spatial neighboring macro-blocks, and/or according to the relationship between the motion vector of the current macro-block and the motion vector of multiple temporal neighboring macro-blocks, the motion detection circuit and the motion detection method are capable of determining whether the current macro-block is the motion macro-block.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A motion detection circuit for a video decoder, comprising:
a motion vector filtering unit, receiving motion vectors of a plurality of macro-blocks in a current video frame provided by the video decoder, wherein, according to a relationship between the motion vector of a current macro-block among the macro-blocks and the motion vector of at least one spatial neighboring macro-block, or according to a relationship between the motion vector of the current macro-block and the motion vector of at least one temporal neighboring macro-block, the motion vector filtering unit determines whether to filter the motion vector of the current macro-block for obtaining a first filtered information of the current macro-block; and
a motion vector decision unit, having an input terminal coupled to an output terminal of the motion vector filtering unit to receive the first filtered information, and determining whether the current macro-block is a motion macro-block according to the first filtered information.

2. The motion detection circuit of claim 1, wherein the motion vector filtering unit comprises:
a motion vector spatial filter, having an input terminal receiving the motion vectors of the macro-blocks, and the motion vector spatial filter determining whether to filter the motion vector of the current macro-block for obtaining a spatial filtered motion vector of the current macro-block according to the relationship between the motion vector of the current macro-block and the motion vectors of the spatial neighboring macro-blocks, so as to obtain the spatial filtered motion vectors of the macro-blocks; and
a motion vector temporal filter, having an input terminal coupled to an output terminal of the motion vector spatial filter to receive the spatial filtered motion vectors of the macro-blocks, and the motion vector temporal filter accumulating the spatial filtered motion vectors of the current macro-blocks at the same position in different video frames for obtaining the first filtered information of the current macro-block in the current video frame.

3. The motion detection circuit of claim 2, wherein the motion vector spatial filter checks a vector angle difference between the motion vector of each of the spatial neighboring macro-blocks and the motion vector of the current macro-block; when one of the vector angle differences is less than a threshold, the motion vector spatial filter maintains the motion vector of the current macro-block to be served as the spatial filtered motion vector; when the vector angle differences are all greater than the threshold, the motion vector spatial filter resets the motion vector of the current macro-block to a first default motion vector representing a non-motion macro-block to be served as the spatial filtered motion vector; and when at least two of the spatial neighboring macro-blocks are the motion macro-blocks, the motion vector spatial filter adjusts the spatial filtered motion vector of the current macro-block reset to the first default motion vector to a second default motion vector representing the motion macro-block.

4. The motion detection circuit of claim 3, wherein the spatial neighboring macro-blocks are two neighboring macro-blocks adjacent to the current macro-block on a column direction and two neighboring macro-blocks adjacent to the current macro-block on a row direction.

5. The motion detection circuit of claim 2, wherein the motion vector temporal filter calculates an equation TMV_{t,x,y}=wₘᵥ*mvs_{t,x,y}+(1−wₘᵥ)*TMV_{(t-1),x,y} for obtaining the first filtered information of the current macro-block in the current video frame, wherein TMV_{t,x,y} represents the first filtered information of a macro-block at a position x,y in a t^{th} video frame, TMV_{(t-1),x,y} represents the first filtered information of the macro-block at the same position x,y in a (t−1)^{th} video frame, mvs_{t,x,y} represents the spatial filtered motion vector of the macro-block at the same position x,y in the t^{th} video frame, wₘᵥ represents a weight, 0≦wₘᵥ≦1, and t, x, y are integers.

6. The motion detection circuit of claim 2, wherein the motion vector temporal filter normalizes the spatial filtered motion vector of the current macro-block in the current video frame for obtaining a normalized motion vector; and the motion vector temporal filter calculates an equation TMV_{t,x,y}=[w₁*TMV_{(t-1),x,y}+w₂*nmv_{t,x,y}]/w₃ for obtaining the first filtered information of the current macro-block in the current video frame, wherein TMV_{t,x,y} represents the first filtered information of a macro-block at a position x,y in a t^{th} video frame, TMV_{(t-1),x,y} represents the first filtered information of the macro-block at the same position x,y in a (t−1)^{th} video frame, nmv_{t,x,y} represents the normalized motion vector of the macro-block at the same position x,y in the t^{th} video frame, w₁, w₂, w₃ are real numbers, and t, x, y are integers.

7. The motion detection circuit of claim 6, wherein w₁+w₂>w₃.

8. The motion detection circuit of claim 1, wherein the motion vector decision unit determines whether the current macro-block is the motion macro-block according to a relationship between the first filtered information and a threshold.

9. The motion detection circuit of claim 1, further comprising:
a macro-block filtering unit, receiving encoding type information of the macro-blocks provided by the video decoder, wherein, according to a relationship between the encoding type information of the current macro-block and the encoding type information of the spatial neighboring macro-block, or according to a relationship between the encoding type info ration of the current macro-block and the encoding type information of the temporal neighboring macro-block, the macro-block filtering unit determines whether to change the encoding type information of the current macro-block for obtaining a second filtered information of the current macro-block; and
a macro-block type decision unit, having an input terminal coupled to an output terminal of the macro-block filtering unit to receive the second filtered information, and determining whether the current macro-block is the motion macro-block according to the second filtered information.

10. The motion detection circuit of claim 9, wherein the macro-block filtering unit comprises:
a macro-block spatial filter, having an input terminal receiving the encoding type information of the macro-blocks, and the macro-block spatial filter determines whether to change the encoding type information of the current macro-block for obtaining a spatial filtered encoding type information of the current macro-block according to a relationship between the encoding type information of the current macro-block and the encoding type information of the spatial neighboring macro-blocks, so as to obtain the spatial filtered encoding type information of the macro-blocks; and
a macro-block temporal filter, having an input terminal coupled to an output terminal of the macro-block spatial filter to receive the spatial filtered encoding type information of the macro-blocks, and the macro-block temporal filter determining whether to accumulate the spatial filtered encoding type information of the current macro-blocks at the same position in different video frames according to the encoding type information of the current macro-block for obtaining the second filtered information of the current macro-block in the current video frame.

11. The motion detection circuit of claim 10, wherein when the encoding type information of the current macro-block is a first encoding type and the encoding type information of one of the spatial neighboring macro-blocks is the first encoding type, the macro-block spatial filter maintains the encoding type information of the current macro-block to be served as the spatial filtered encoding type information; otherwise, the macro-block spatial filter resets the encoding type information of the current macro-block to a first default encoding type information representing a non-motion macro-block to be served as the spatial filtered encoding type information.

12. The motion detection circuit of claim 10, wherein when the encoding type information of the current macro-block is a first encoding type, the macro-block temporal filter calculates an equation AMV_{t,x,y}=AMV_{(t-1),x,y}+1 for obtaining the second filtered information of the current macro-block in the current video frame, and when the encoding type information of the current macro-block is a second encoding type, the macro-block temporal filter sets AMV_{t,x,y} to 0, wherein AMV_{t,x,y} represents the second filtered information of a macro-block at a position x,y in a t^{th} video frame, AMV_{(t-1),x,y} represents the second filtered information of the macro-block at the same position x,y in a (t−1)^{th} video frame, and t, x, y are integers.

13. The motion detection circuit of claim 9, wherein the macro-block type decision unit determines whether the current macro-block is the motion macro-block according to a relationship between the second filtered information and a threshold.

14. The motion detection circuit of claim 9, further comprising:
a frame motion detector, having two input terminals respectively coupled to an output terminal of the macro-block type decision unit and an output terminal of the motion vector decision unit, and the frame motion detector counting a block amount of the macro-blocks determined as the motion macro-block in the current video frame, and determining whether the current video frame is a motion video frame according to the block amount.

15. The motion detection circuit of claim 1, further comprising:
a frame motion detector, having an input terminal coupled to an output terminal of the motion vector decision unit, and the frame motion detector counting a block amount of the macro-blocks determined as the motion macro-block in the current video frame, and determining whether the current video frame is a motion video frame according to the block amount.

16. A motion detection method for a video decoder, comprising:
receiving motion vectors of a plurality of macro-blocks in a current video frame provided by the video decoder;
according to a relationship between the motion vector of a current macro-block among the macro-blocks and the motion vector of at least one spatial neighboring macro-block among the macro-blocks, or according to a relationship between the motion vector of the current macro-block and the motion vector of at least one temporal neighboring macro-block, determining whether to filter the motion vector of the current macro-block for obtaining a first filtered information of the current macro-block; and
determining whether the current macro-block is a motion macro-block according to the first filtered information.

17. The motion detection method of claim 16, wherein the step of obtaining the first filtered information of the current macro-block comprises:
determining whether to filter the motion vector of the current macro-block for obtaining a spatial filtered motion vector of the current macro-block according to the relationship between the motion vector of the current macro-block and the motion vectors of the spatial neighboring macro-blocks, so as to obtain the spatial filtered motion vectors of the macro-blocks; and
accumulating the spatial filtered motion vectors of the current macro-blocks at the same position in different video frames for obtaining the first filtered information of the current macro-block in the current video frame.

18. The motion detection method of claim 17, wherein the step of obtaining the spatial filtered motion vector of the current macro-block comprises:
checking a vector angle difference between the motion vector of each of the spatial neighboring macro-blocks and the motion vector of the current macro-block;
when one of the vector angle differences is less than a threshold, maintaining the motion vector of the current macro-block to be served as the spatial filtered motion vector;
when the vector angle differences are all greater than the threshold, resetting the motion vector of the current macro-block to a first default motion vector representing a non-motion macro-block to be served as the spatial filtered motion vector; and
when at least two of the spatial neighboring macro-blocks are the motion macro-blocks, adjusting the spatial filtered motion vector of the current macro-block reset to the first default motion vector to a second default motion vector representing the motion macro-block.

19. The motion detection method of claim 18, wherein the spatial neighboring macro-blocks are two neighboring macro-blocks adjacent to the current macro-block on a column direction and two neighboring macro-blocks adjacent to the current macro-block on a row direction.

20. The motion detection method of claim 17, wherein the step of obtaining the first filtered information of the current macro-block in the current video frame comprises:
calculating an equation TMV_{t,x,y}=wₘᵥ*mvs_{t,x,y}+(1−wₘᵥ)*TMV_{(t-1),x,y} for obtaining the first filtered information of the current macro-block in the current video frame, wherein TMV_{t,x,y} represents the first filtered information of a macro-block at a position x,y in a t^{th} video frame, TMV_{(t-1),x, y} represents the first filtered information of the macro-block at the same position x,y in a (t−1)^{th} video frame, mvs_{t,x,y} represents the spatial filtered motion vector of the macro-block at the same position x,y in the t^{th} video frame, wₘᵥ represents a weight, 0≦wₘᵥ≦1, and t, x, y are integers.

21. The motion detection method of claim 17, wherein the step of obtaining the first filtered information of the current macro-block in the current video frame comprises:
normalizing the spatial filtered motion vector of the current macro-block in the current video frame for obtaining a normalized motion vector; and
calculating an equation TMV_{t,x,y}=[w₁*TMV_{(t-1),x,y}+w₂*nmv_{t,x,y}]/w₃ for obtaining the first filtered information of the current macro-block in the current video frame, wherein TMV_{t,x,y} represents the first filtered information of a macro-block at a position x,y in a t^{th} video frame, TMV_{(t-1),x,y} represents the first filtered information of the macro-block at the same position x,y in a (t−1)^{th} video frame, nmv_{t,x,y} represents the normalized motion vector of the macro-block at the same position x,y in the t^{th} video frame, w₁, w₂, w₃ are real numbers, and t, x, y are integers.

22. The motion detection method of claim 21, wherein w₁+w₂>w₃.

23. The motion detection method of claim 16, wherein the step of determining whether the current macro-block is the motion macro-block according to the first filtered information comprises:
determining whether the current macro-block is the motion macro-block according to a relationship between the first filtered information and a threshold.

24. The motion detection method of claim 16, further comprising:
receiving encoding type information of the macro-blocks provided by the video decoder;
according to a relationship between the encoding type information of the current macro-block and the encoding type information of the spatial neighboring macro-block, or according to a relationship between the encoding type information of the current macro-block and the encoding type information of the temporal neighboring macro-block, determining whether to change the encoding type information of the current macro-block for obtaining a second filtered information of the current macro-block; and
determining whether the current macro-block is the motion macro-block according to the second filtered information.

25. The motion detection method of claim 24, wherein the step of obtaining the second filtered information of the current macro-block comprises:
determining whether to change the encoding type information of the current macro-block for obtaining a spatial filtered encoding type information of the current macro-block according to a relationship between the encoding type information of the current macro-block and the encoding type information of the spatial neighboring macro-blocks, so as to obtain the spatial filtered encoding type information of the macro-blocks; and
determining whether to accumulate the spatial filtered encoding type information of the current macro-blocks at the same position in different video frames according to the encoding type information of the current macro-block for obtaining the second filtered information of the current macro-block in the current video frame.

26. The motion detection method of claim 25, wherein when the encoding type information of the current macro-block is a first encoding type and the encoding type information of one of the spatial neighboring macro-blocks is the first encoding type, maintaining the encoding type information of the current macro-block to be served as the spatial filtered encoding type information; otherwise, resetting the encoding type information of the current macro-block to a first default encoding type information representing a non-motion macro-block to be served as the spatial filtered encoding type information.

27. The motion detection method of claim 25, wherein when the encoding type information of the current macro-block is a first encoding type, calculating an equation AMV_{t,x,y}=AMV_{(t-1),x,y}+1 for obtaining the second filtered information of the current macro-block in the current video frame, and when the encoding type information of the current macro-block is a second encoding type, setting AMV_{t,x,y} to 0, wherein AMV_{t,x,y} represents the second filtered information of a macro-block at a position x,y in a t^{th} video frame, AMV_{(t-1),x,y} represents the second filtered information of the macro-block at the same position x,y in a (t−1)^{th} video frame, and t, x, y are integers.

28. The motion detection method of claim 24, wherein the step of determining whether the current macro-block is the motion macro-block according to the second filtered information comprises:
determining whether the current macro-block is the motion macro-block according to a relationship between the second filtered information and a threshold.

29. The motion detection method of claim 24, further comprising:
counting a block amount of the macro-blocks determined as the motion macro-block in the current video frame according to the first filtered information or the second filtered information; and
determining whether the current video frame is a motion video frame according to the block amount.

30. The motion detection method of claim 16, further comprising:
counting a block amount of the macro-blocks determined as the motion macro-block in the current video frame; and
determining whether the current video frame is a motion video frame according to the block amount.
